(19) United States
(12) Patent Application Publication
(10) Pub. No.: US 2026/0117411 A1
(43) Pub. Date: Apr. 30, 2026

(54) PROCESS FOR PRODUCING A GRAPHITE-CONTAINING METAL OXIDE ELECTRODE, GRAPHITE-CONTAINING METAL OXIDE ELECTRODE, USE OF THE GRAPHITE-CONTAINING METAL OXIDE ELECTRODE AND ELECTROLYSIS CELL

(71) Applicant: ENINNO GMBH, Berlin (DE)

(72) Inventors: Matthias DRIESS, Berlin (DE); Carsten WALTER, Berlin (DE); Lukas REITH, Berlin (DE); Prashanth Wilfried MENEZES, Berlin (DE)

(73) Assignee: ENINNO GMBH, Berlin (DE)

(21) Appl. No.: 18/835,525

(22) PCT Filed: Feb. 1, 2023
(86) PCT No.: PCT/DE2023/100081

§ 371 Date: Aug. 22, 2024

(30) Foreign Application Priority Data
Feb. 2, 2022 (DE) 10 2022 102 484.9
Nov. 15, 2022 (DE) 10 2022 130 157.5

(51) Int. Cl. C25D 9/04; C25B 11/052; C25B 11/067; C25D 3/12; C25D 3/20; C25D 3/44; C25D 3/54; H01M 10/54

(52) U.S. Cl. CPC C25D 9/04; C25B 11/052; C25B 11/067; C25D 3/12; C25D 3/20; C25D 3/44; C25D 3/54; H01M 10/54

(57) ABSTRACT

A process for producing a graphite-containing metal oxide electrode includes: a) providing an electrolysis cell having an electrode, a further electrode and an aqueous and/or non-aqueous carbonyl-and cyano-free solvent, b) introducing black matter and a proton source into the solvent present in the electrolysis cell, where the black matter includes graphite-supported precious metal-free metal oxides, and c) applying a voltage to the electrode and the further electrode, such that the precious metal-free metal oxides and graphite provided by means of the black matter are deposited on the electrode to produce a graphite-containing metal oxide coating on the electrode for formation of the graphite-containing metal oxide electrode. The graphite-containing metal oxide electrode is used for production of hydrogen and/or oxygen by (photo)electrochemical water splitting and to an electrolysis cell for production of hydrogen and oxygen by (photo)electrochemical water splitting.

The invention relates to a process for producing a graphite-containing metal oxide electrode, to a graphite-containing metal oxide electrode, to the use of the graphite-containing metal oxide electrode and to an electrolysis cell. In particular, the invention relates to an easy-to-perform process for producing a graphite-containing metal oxide electrode, to the graphite-containing metal oxide electrode produced by the method, to the use of the graphite-containing metal oxide electrode for electrochemically producing hydrogen and/or oxygen, and to an electrolysis cell configured to produce hydrogen and oxygen using the graphite-containing metal oxide electrode.

A process for producing a carbon-containing metal oxide electrode is known from WO2015/082626 A1, which describes a process for producing a metal chalcogenide thin-film electrode.

### The process for producing the metal chalcogenide thin-film electrode comprises the steps of:

(a) contacting a metal or metal oxide with an elementary halogen in a nonaqueous solvent to produce a metal halide compound in the solution,
(b) applying a negative electric voltage to an electrically conducting or semiconducting substrate that is in contact with the solution from step (a), and
(c) during and/or after step (b), contacting the substrate with an elementary chalcogen to form a metal chalcogenide layer on the substrate.

This uses a metal that can form a metal halide compound in which the metal is in the +2 oxidation state or higher, in particular Fe, Co, Ni, Cr, Mn or the mixtures or alloys thereof. The halogens are in particular iodine or bromine. The chalcogens are in particular O₂, S or Se. The nonaqueous solvent used is an organic solvent preferably comprising a carbonyl group (CO) or cyanide group (CN). The metal chalcogenide thin-film electrode produced by means of the process can be used for (photo)electrochemical water splitting and is used in particular as an electrode for the evolution of oxygen for electrochemical water splitting under an applied external potential or under illumination. However, the process is complex as it is necessary to first produce a precursor for the deposition. There is therefore a need to provide an electrode that is suitable as an electrode for use in electrochemical water splitting and that is easy to produce.

It is therefore an object of the invention to provide a process for producing an electrode that is easy to perform and results in an electrode that is suitable for electrochemical use in water splitting.

The object is achieved by a process having the features of patent claim 1, a graphite-containing metal oxide electrode having the features of patent claim 7, the use of the graphite-containing metal oxide electrode having the features of patent claim 8 and an electrolysis cell having the features of patent claim 9. Advantageous developments and modifications are specified in the dependent claims.

The invention relates to a process for producing a graphite-containing metal oxide electrode, comprising the following steps
a) providing an electrolysis cell having an electrode, a further electrode and an aqueous and/or nonaqueous carbonyl-and cyano-free solvent,
b) introducing black mass and a proton source into the solvent in the electrolysis cell, the black mass having graphite-supported noble metal-free metal oxides, and
c) applying a voltage to the electrode and the further electrode, so that the noble metal-free metal oxides and graphite provided by means of the black mass are deposited on the electrode in order to produce a graphite-containing metal oxide coating on the electrode to form the graphite-containing metal oxide electrode.

No precursors for the production of chalcogenides are used to produce the graphite-containing metal oxide electrode. Rather, use is directly made of the metal oxides that are present in the black mass and have optionally been modified with respect to their percentage ratios. Carbonyl and cyano group-free solvents are used. Use is preferably made of cyclic ethers such as tetrahydrofuran and azeotropic alcohol-water mixtures at a cell voltage below 10 V. Examples of materials of the electrodes are nickel- or steel-based materials.

The protons originate from a weakly Brønsted-acidic proton source (molecules as solvents having OH, C—H and N—H groups). A preferred source for protons is based on a reaction of the bromine and iodine with the solvent. Alternatively, use may also be made of a highly diluted solution of hydrogen bromide or hydrogen iodide (10⁻⁴ to 10⁻⁶ molar) in suitable solvents, which can be produced by addition of hydrogen bromide or hydrogen iodide to the solvent. The protons act as mediator in the fixing of the catalyst on the electrode.

In a preferred embodiment, the black mass is a recyclate. The recyclate is preferably a recycled material from a used battery for electrically driving an electric vehicle, more preferably electric car. The black mass is a material obtained from used batteries that have been used to electrically drive an electric vehicle, more preferably electric car. In particular, the black mass is obtained by means of mechanical recycling by dismantling a used electric car battery to be recycled. After dismantling of the housing and the device electronics of the used battery, the mechanical recycling comprises several comminution, sorting and classification steps of the remainder, from which, inter alia, the black mass is obtained and processed. The black mass was provided by Duesenfeld GmbH (Wendeburg, Germany). The black mass preferably comprises layer, electrode and/or electrolyte materials of the used battery. It is preferably a granule mixture. The active materials of the electrodes such as graphite and lithium-transition metal mixed oxides, such as cobalt, nickel and manganese, are preferably enriched in the black mass. The composition of the black mass is however dependent on the chemical composition of the recycled used battery. There are different types of electric vehicle drive batteries that have different chemical compositions.

In addition to metal(s) and metal oxide(s), the black mass contains graphite that acts as a support for the metal(s) and metal oxide(s). The black mass preferably contains several metal oxides. The black mass preferably comprises mixed metal oxides such as oxides of Ni, Co, and Mn. Alternatively, the black mass preferably comprises oxides of Ni, Co and Al. Alternatively, the black mass preferably also comprises iron oxides obtained from a used battery based on iron phosphates Feₓ(PO₄)_{y}. The metal oxides of the black mass may consist of mixed Ni, Co, Mn oxides, Ni, Co, Al oxides or iron oxide(s) supported on graphite. The metals (or metal oxides) are free of noble metals.

Preferably, the one or more graphite-supported metal oxides comprise a mixture of Ni, Co and/or Mn and at least one of their oxides. The Ni: Mn: Co ratio can vary in the black mass depending on the wet-chemical processing method for removing lithium and other constituents in the cathode and is also dependent on the particle size of the black mass after recycling.

Established materials for electric car lithium batteries that can be used to produce the black mass are described for example by Harper, G. et al. Nature 575, 75-86 (2019): LiFePO₄, LiMn₂O₄, Li(Ni, Co, Al)O₂, LiNi_{0.33}Mn_{0.33}Co_{0.33}O₂, LiNi_{0.5}Mn_{0.3}Co_{0.2}O₂, LiNi_{0.6}Mn_{0.2}Co_{0.2}O₂ and LiNi_{0.8}Nm_{0.1}Co_{0.1}O₂. Particularly preferred materials are: LiFePO₄, LiMn₂O₄, Li(Ni, Co, Al)O₂, LiNi_{0.33}Mn_{0.33}Co_{0.33}O₂, LiNi_{0.5}Mn_{0.3}Co_{0.2}O₂, LiNi_{0.6}Mn_{0.2}Co_{0.2}O₂ and LiNi_{0.8}Nm_{0.1}Co_{0.1}O₂.

Preferably, the black mass used is a recyclate from a used battery for electrically driving an electric vehicle as recycled material based on an NMC battery (lithium nickel manganese cobalt oxide battery) from Duesenfeld GmbH (Wendeburg, Germany). The recyclate comprises 48.04% by weight of C, 16.16% by weight of O, 2.91% by weight of Ni, 0.52% by weight of Co, 0.30% by weight of Fe and 32.07% by weight of N. The morphology has micro-and/or nanostructures. The morphology and particle size are inhomogeneous.

Alternatively, the black mass used is preferably a recyclate from a used battery for electrically driving an electric vehicle as recycled material based on an LFP battery (lithium iron phosphate battery) from Duesenfeld GmbH (Wendeburg, Germany). The recyclate comprises 31.90% by weight of C, 36.87% by weight of O, 19.30% by weight of Fe and 11.94% by weight of P. The morphology has micro-and/or nanostructures. The morphology and particle size are inhomogeneous.

In a preferred embodiment, before step a) or step b), the following steps are carried out
determining the composition and morphology of the black mass and
chemically modifying the black mass depending on the determined composition and morphology, comprising a modification of the percentages of metal (oxide) present in the black mass.

The percentages of the elements present in the black mass are preferably predefined as maximum value by the wet-chemical processing of the cathode materials of the lithium battery. Since the percentages of different batches and battery types can vary anyway, it is advantageous to determine the exact composition and morphology of the black mass and to subsequently chemically modify it in order to increase the level of performance of the graphite-containing metal oxide electrode to be produced. Preferably, a predetermined ratio of the metal oxide proportions present in the black mass is established by way of the chemical modification.

The composition and morphology of the black mass is known on the basis of data and/or safety data sheets provided by the manufacturer of the black mass and/or can be determined by means of solid-state analysis (for example X-ray photoelectron spectroscopy (XPS), energy-dispersive X-ray spectroscopy (EDX), scanning electron microscopy (SEM), transmission electron microscopy (TEM)), powder X-ray diffraction (PXRD) and/or by wet-chemical analysis (for example ion chromatography with plasma (ICP)).

X-ray photoelectron spectroscopy (XPS) can be carried out for the chemical analysis of the black mass, it being possible to assign the nuclear level lines to specific oxidation states using published data such as Chastain & King (Ed.), Handbook of X-Ray Photoelectron Spectroscopy, Physical Electronics, Minnesota, USA, (1995).

Energy-dispersive X-ray analysis (EDX) can be carried out for the chemical elemental analysis both integrally, i.e. averaging over an entire sample surface of the black mass, and locally, i.e. with lateral resolution on the scanning electron microscope, where excitation energies are selected such that expected element-specific K- or L-lines of the elements can be detected, for example between 3 keV and 10 keV. The measured X-ray lines can be assigned in an automated manner with the aid of database values by control software such as NSS 2.2, Thermo Fisher Scientific, USA.

In a preferred embodiment, the chemical modification of the black mass comprises a modification of the percentages of metal (oxide) present in the black mass. Optimizing the percentage composition of the metal oxides appears advantageous in the light of publications by Cao X. et al, ACS Catal. 8, 8273-8289 (2018) and Lu Z. et al., Nat. Commun. 5, 4345 (2014) on the use of mixed ternary metal oxides obtained from recycled Li batteries, i.e. pure metal oxides without graphite.

The chemical modification comprises for example addition of metal (oxide) to obtain an optimal ratio of the metals and an optimized surface of the black mass particles. The metal (oxide) used here may be the same as the metals (or metal oxides) already present in the black mass, with the result that their proportions in the black mass are modified relative to one another. Alternatively or additionally, the metal (oxide) used here may be a metal (oxide) different to the metals (or metal oxides) already present in the black mass. The composition of the black mass may also be changed by treating the black mass with molecular hydrogen as reducing agent at 300-400° C., which can lead to the partial formation of metal alloys such as NiCo that can be used to increase the efficiency of the black mass for water splitting.

The metal (oxide) added for the chemical modification of the black mass may also be produced in situ. For example, Ni(OAc)₂ (nickel(II) acetate) may be added to the black mass and subjected to conditions that lead to a decomposition reaction of the Ni(OAc)₂ to form nickel(II) oxide and nickel.

It is further possible to modify the black mass by modifying existing metal oxide structures and/or support materials by means of anion/cation exchange under acidic or basic conditions. For example, the black mass may be heated in an aqueous solution of formic acid and H₂O₂ in order to bring about anion/cation exchange under acidic conditions. An anion/cation exchange under basic conditions may be realized by heating the black mass in an aqueous KOH solution.

The chemical modification of the black mass may further comprise a chemical modification of the graphite as support. To this end, before step a) or b), the following step is preferably carried out:
adding one or more extraneous atoms (promoter atoms) to the graphite support of the black mass.

The extraneous atom(s) is/are preferably selected from the group consisting of nitrogen, sulfur, phosphorus and/or boron. More preferably, the extraneous atom(s) is/are nitrogen and/or sulfur.

In a preferred embodiment, the extraneous atom is nitrogen. Adding nitrogen to the graphite makes it possible to increase a level of performance and current density by at least 50% in the case of electrolytic hydrogen formation for example with Ni/Co/Mn-containing black mass. The addition may be effected here in amounts in the range from doping to substoichiometric. To add nitrogen to the graphite, the black mass is preferably heated in an ammonia gas stream as nitrogen source for 1 h or several hours, preferably 1 to 10 h, at 200° C. to 400° C., more preferably 300-350° C. Nitrogen is demonstrably taken up in the graphite carrier as a result. The evidence of nitrogen in the material can be provided on the basis of XPS (X-ray photoelectron spectroscopy) emission spectra. Alternatively, nitrogen may be added using N₂, urea or hydrazine.

Alternatively or additionally, the extraneous atom is preferably sulfur. The addition of sulfur leads to a drastic increase in activity of the black mass in hydrogen production. The addition of sulfur results in the slight formation of metal sulfides such as NiS, CoS and MnS, if these metals are present in the black mass, which can promote electrolytic hydrogen formation. Sulfur may be added for example using Ss or hydrogen sulfide.

Sulfur and nitrogen may be added at the same time by reacting the black mass with thiourea, which simultaneously serves as a nitrogen and sulfur source. For example, 0.1-0.3% by weight of thiourea is used. The reaction may be carried out at 150-200° C. over several hours.

Alternatively or additionally, the extraneous atom is preferably phosphorus. Phosphorus may be added for example using red phosphorus.

Alternatively or additionally, the extraneous atom is preferably boron. Boron may be added for example using boric acid or diboron trioxide.

In a preferred embodiment, the solvent is selected from the group consisting of cyclic ethers and/or azeotropic alcohol-water mixtures. It has been found that even difficult-to-oxidize cyclic ethers such as tetrahydrofuran and azeotropic alcohol-water mixtures may be used in the process at a cell voltage of below 10 V.

The invention further relates to a graphite-containing metal oxide electrode produced by one of the processes according to one or more of the embodiments described above.

The graphite-containing metal oxide electrode comprises one of the electrodes originally used in the process in the form of an electrically conducting or semiconducting substrate and a layer of graphite-supported metal oxides and optionally extraneous atoms and/or metals (or metal alloys) that is deposited thereon by means of the process. The graphite support provides a required strength and imperviousness of the layer deposited on the substrate. Both the charge transport from the substrate to the metal oxides is optimized and the stability of the substrate is increased.

The graphite-containing metal oxide electrode preferably comprises a layer deposited on the substrate with a thickness of up to several micrometers, more preferably up to 10 μm. The thicker the layer, the longer it lasts during operation and higher current densities can be achieved during operation.

The graphite-containing metal oxide electrode may also be provided here in a module form that has layers of several electrodes. Such an electrode in module form is not comparable to a laboratory-scale electrolysis cell having a maximum size of 1 cm². Preferably, the graphite-containing metal oxide electrode has a size of greater than 1 cm², preferably greater than 16 cm², even more preferably in the range from 0.16 to 2.5 m².

The invention further relates to the use of the graphite-containing metal oxide electrode for producing hydrogen and/or oxygen by means of (photo)electrochemical water splitting. The graphite-containing metal oxide electrode may be used both as anode and as cathode in electrochemical water splitting. That is to say, it may be used to produce oxygen and/or hydrogen in water splitting by means of electrolysis. The above should be understood to mean that a graphite-containing metal oxide electrode is not used simultaneously as anode and cathode during the electrochemical water splitting, but rather one graphite-containing metal oxide electrode produced by the above process is used as anode, while a further graphite-containing metal oxide electrode produced by the above process is used as cathode.

Industrial-scale use of the graphite-containing metal oxide electrode is possible. The graphite-containing metal oxide electrode is particularly suitable for the industrial-scale production of hydrogen. This hydrogen is also referred to as green hydrogen, as it can be produced in an environmentally friendly manner from renewable energy sources (electric current). However, it is advantageous to produce several graphite-containing metal oxide electrodes by the above process and to use one of the produced graphite-containing metal oxide electrodes as electrode for hydrogen production and a further produced graphite-containing metal oxide electrode as anode for the production of oxygen in the electrochemical overall water splitting.

Furthermore, the invention relates to an electrolysis cell for producing hydrogen and oxygen by means of (photo)electrochemical water splitting, comprising the graphite-containing metal oxide electrode according to one or more of the embodiments described above as cathode and/or the graphite-containing metal oxide electrode according to one or more of the embodiments described above as anode.

In a preferred embodiment, the electrolysis cell comprises an alkaline solution as electrolysis solution. The alkaline solution preferably comprises 0 to 6 moles of KOH, with the electrolysis cell having an alkali exchange membrane (AEM) in the case of the 0 molar KOH solution. The electrolysis cell is preferably configured to perform the electrolysis in a temperature range from room temperature to 80° C. The overall cell voltage for complete water splitting is in the range from 1.23 to 2.5 V with current densities of 100-1000 mA per square centimeter (cm⁻²).

The electrolysis cell is preferably configured in an industrial-scale manner in order to produce hydrogen on an industrial scale. The graphite-containing metal oxide electrode may be produced with the process according to the invention as a large-area electrode in a size of 0.16 to 2.5 square meters. At a current density of 1000 mA cm⁻², the electrolysis cell can produce up to 8 tons of H₂ (=4×10⁶ mol) per electrode per year using a 2.5 m² graphite-containing metal oxide electrode.

The invention is further elucidated in more detail below with reference to the accompanying drawings and examples. In the figures, schematically and not to scale:

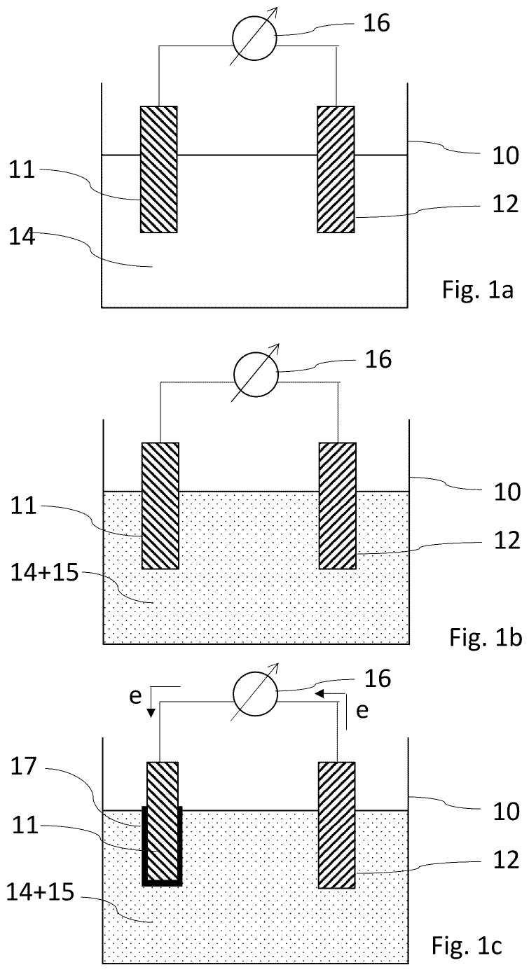

FIGS. 1a to 1c show a flow diagram of a process according to one embodiment,

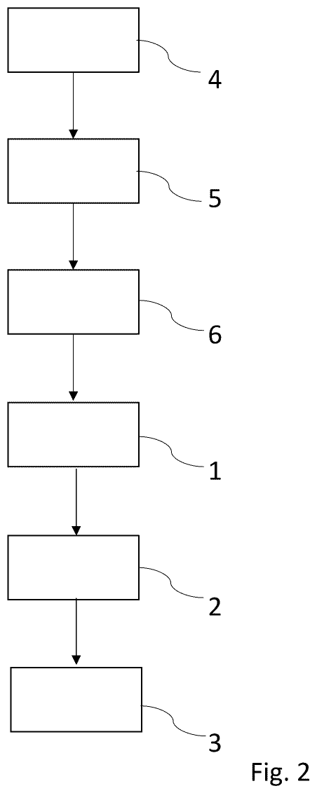

FIG. 2 shows a flow diagram of a process according to a further embodiment,

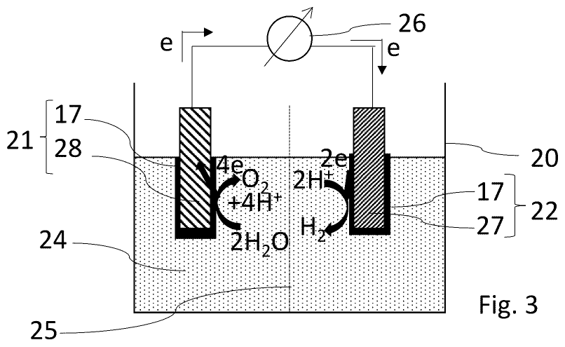

FIG. 3 shows a cross-sectional view of an electrolysis cell according to the invention,

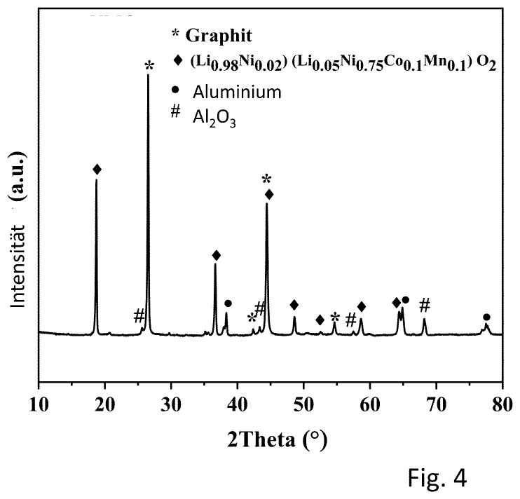

FIG. 4 shows a powder diffractogram of a black mass,

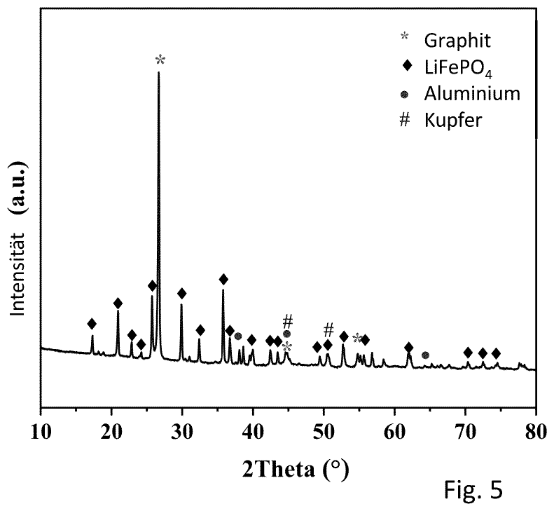

FIG. 5 shows a powder diffractogram of a further black mass,

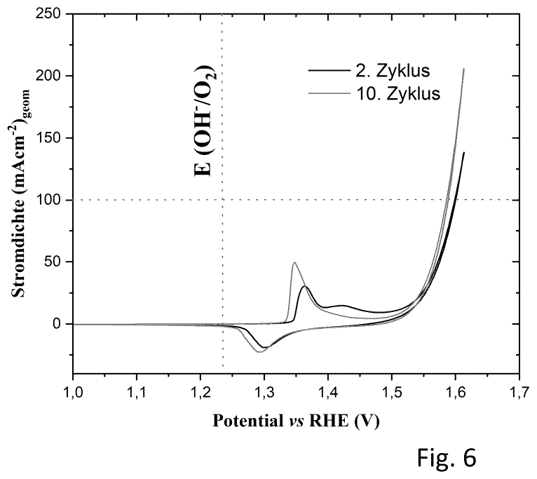

FIG. 6 shows a cyclic voltammogram of a graphite-containing metal oxide electrode according to the invention, and

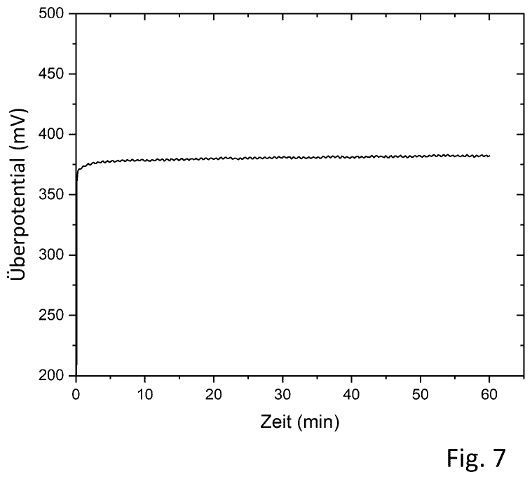

FIG. 7 shows a chronopotentiometry of the graphite-containing metal oxide electrode shown in FIG. 6.

FIGS. 1a to 1c show a flow diagram of a process according to one embodiment. Shown in each case is a cross-sectional view of an electrolysis cell in which the graphite-containing metal oxide electrode according to the invention is produced. FIG. 1a shows a step in which an electrolysis cell 10 having an electrode 11, a further electrode 12 and an aqueous and/or nonaqueous carbonyl-and cyano-free solvent 14 is provided. FIG. 1b shows the subsequent step in which black mass 15 is introduced into the solvent 14 in the electrolysis cell 10, the black mass 15 having graphite-supported noble metal-free metal oxides. FIG. 1c shows a subsequent step in which a voltage is applied to the electrode 11 and the further electrode 12, so that the noble metal-free metal oxides and graphite provided by means of the black mass 15 are deposited on the electrode 11 in order to produce a graphite-containing metal oxide coating 17 on the electrode 11 to form the graphite-containing metal oxide electrode.

FIG. 2 shows a flow diagram of a process according to a further embodiment. The process involves first carrying out a step of determining 4 the composition and morphology of the black mass and subsequently a step of chemically modifying 5 the black mass depending on the composition and morphology determined in step 4, in which chemical modification step, starting from the ratio of the metal oxide proportions present in the black mass, the ratio is changed in order to achieve a higher level of performance and longer stability of the graphite-containing electrode to be produced when used in electrochemical water splitting. Optionally carried out subsequently is a step of adding 6 one or more extraneous atoms (promoter atoms) such as nitrogen, sulfur and/or phosphorus to the graphite support of the black mass. Step 5 or the optional step 6 is followed by providing 1 an electrolysis cell having an electrode, a further electrode and an aqueous and/or nonaqueous carbonyl-and cyano-free solvent. Following step 1 is a step 2 of introducing the black mass into the solvent in the electrolysis cell. Following step 2 is a step 3 of applying a voltage to the electrode and the further electrode, so that the noble metal-free metal oxides and graphite provided by means of the black mass are deposited on the electrode in order to produce a graphite-containing metal oxide coating on the electrode to form the graphite-containing metal oxide electrode.

FIG. 3 shows a cross-sectional view of an electrolysis cell according to the invention. The electrolysis cell 20 is configured to produce hydrogen and oxygen by means of (photo)electrochemical water splitting. It has two graphite-containing metal oxide electrodes according to the invention that have been produced for example by the process shown in FIGS. 1a-1c or 2. One of the graphite-containing metal oxide electrodes serves as cathode 22, while the other graphite-containing metal oxide electrode serves as anode 21. The cathode 22 comprises a substrate 27 provided with a coating 17 of graphite-supported metal oxide(s). The anode 21 comprises a further substrate 28 provided with the coating 17. Furthermore, the electrolysis cell 20 comprises an alkaline solution 24. It also has a diaphragm 25 for example in the form of an AEM, which separates an anode space and a cathode space.

Current is applied to the cathode 22 and the anode 21 during operation of the electrolysis cell 20, with the result that water is split. Oxygen is formed at the anode 21, while hydrogen is formed at the cathode 22.

FIG. 4 shows a powder diffractogram of a black mass. The powder diffractogram shows a composition of the black mass described as a recyclate in Example 2 below.

FIG. 5 shows a powder diffractogram of a further black mass. The powder diffractogram shows a composition of the black mass described as a recyclate in Example 3 below.

FIG. 6 shows a cyclic voltammogram of a graphite-containing metal oxide electrode according to the invention with a scan rate of 5 mV/s. The measurements according to a 2nd cycle and a 10th cycle were effected in a three-electrode configuration. Use was made of an Hg/HgO reference electrode, the potentials of which were based on the reversible hydrogen electrode (RHE). To produce the graphite-containing metal oxide electrode according to the invention, use was made of the black mass produced in Example 2-5 below, which was subjected to a process corresponding to that described in Example 1 using an Ni foam. The graphite-containing metal oxide electrode thus produced was used as the working electrode for the production of oxygen.

FIG. 7 shows a chronopotentiometry of this graphite-containing metal oxide electrode at 100 mA/cm².

### Example 1

### Production of a Graphite-Containing Metal Oxide Electrode

To produce a graphite-containing metal oxide electrode according to the invention, an electrolysis cell having an electrode for example based on an Ni, Fe and/or Cu foam and a further electrode made of steel in a solvent in the form of 10 ml of cyclic ether such as tetrahydrofuran is provided. 25 mg of black mass and 2 mg of iodine are introduced into the solution. A voltage of 10 V is subsequently applied to the electrodes at room temperature in air over a period of 30 s to 10 min. The 2 mg of iodine and 25 mg of black mass are sufficient to produce 10 to 15 graphite-containing metal oxide electrodes. The graphite-containing metal oxide electrodes produced in this way are washed with organic solvent and air-dried.

### Example 2

### Determination of the Composition and Morphology of Black Mass

The black mass used is a recyclate from a used battery for electrically driving an electric vehicle, particularly an electric car. The recyclate is a recycled material based on an NMC battery (lithium nickel manganese cobalt oxide battery), which was provided by Duesenfeld GmbH (Wendeburg, Germany). The one or more graphite-supported noble metal-free metal oxides of the black mass comprise a mixture of Ni, Co and Mn and at least one of their oxides. In addition to different types of graphite, the recyclate comprises (Li_{0.98}Ni_{0.02})(Li_{0.05}Ni_{0.75}Co_{0.10}Mn_{0.10})O₂, aluminum and Al₂O₃. FIG. 4 shows a powder diffractogram of this black mass.

### Example 2-1

### Chemical Modification of the Black Mass

500 mg of the black mass used in Example 2 was added to an autoclave with 0.05 g of Ni(OAc)₂ and 30 ml of water and heated to 180° C. for 16 h. The suspension was cooled naturally in the furnace, washed with water and acetone and air-dried.

### Example 2-2

### Chemical Modification of the Black Mass

500 mg of the black mass used in Example 2 was added to an autoclave with 0.1 g of Ni(OAc)₂ and 30 ml of water and heated to 180° C. for 16 h. The suspension was cooled naturally in the furnace, washed with water and acetone and air-dried.

### Example 2-3

### Chemical Modification of the Black Mass

100 mg of the black mass used in Example 2 was ground and heated to 80° C. in an aqueous solution of 2 M formic acid and 6% H₂O₂ for 2 h. Subsequently, the material was washed with water and acetone and air-dried.

### Example 2-4

### Chemical Modification of the Black Mass

100 mg of the black mass used in Example 2 was ground and heated to 80° C. in an aqueous solution of 1 M KOH for 2 h. Subsequently, the material was washed with water and acetone and air-dried.

### Example 2-5

### Addition of Nitrogen As Extraneous Atom

100 mg of the black mass used in Example 2 was first flushed with NH₃ in a tubular furnace for 2 h and subsequently heated to 300° C. (ramp 300° C./h). After 6 h, natural cooling to room temperature was performed.

### Example 2-6

### Addition of Nitrogen As Extraneous Atom

100 mg of the black mass used in Example 2 was first flushed with NH₃ in a tubular furnace for 2 h and subsequently heated to 400° C. (ramp 300° C./h).

After 6 h, natural cooling to room temperature was performed.

### Example 2-7

### Addition of Nitrogen as Extraneous Atom 100 mg of the black mass used in Example 2 was first flushed with NH₃ in a tubular furnace for 2 h and subsequently heated to 200° C. (ramp 300° C./h).

After 6 h, natural cooling to room temperature was performed.

### Example 2-8

### Addition of Nitrogen as Extraneous Atom

100 mg of the black mass used in Example 2 was first flushed with NH₃ in a tubular furnace for 2 h and subsequently heated to 350° C. (ramp 300° C./h). After 6 h, natural cooling to room temperature was performed.

### Example 2-9

### Addition of Nitrogen as Extraneous Atom 100 mg of the black mass used in Example 2 was first flushed with NH₃ in a tubular furnace for 2 h and subsequently heated to 250° C. (ramp 300° C./h).

After 6 h, natural cooling to room temperature was performed.

### Example 2-10

### Addition of Nitrogen as Extraneous Atom

100 mg of the black mass used in Example 2 was added to a solution of ethanol (40 ml) and urea (1.5 g) and suspended for 2 h in an ultrasound bath. The solvent was evaporated in an N₂ stream over a period of 2 hours. The product formed was ground and placed in a tubular furnace, which was flushed with Nz for 1 h. The black mass obtained in this way was then heated to 300° C. (ramp 300° C./h) and the temperature was maintained for 2 hours before being allowed to cool naturally.

### Example 2-11

### Addition of Nitrogen As Extraneous Atom

100 mg of the black mass used in Example 2 was ground and placed in a tubular furnace. The system was flushed with N₂ for 1 hour. The black mass treated in this way was then heated to 300° C. (ramp 300° C./h) and the temperature was maintained for 2 h before being allowed to cool naturally.

### Example 2-12

### Addition of Nitrogen as Extraneous Atom

500 mg of the black mass used in Example 2 was added to an autoclave with 1.5 g of urea and 30 ml of water and heated to 180° C. for 16 h. The suspension was cooled naturally in the furnace, washed with water and acetone and air-dried.

### Example 2-13

### Addition of Nitrogen and Sulfur as Extraneous Atoms

500 mg of the black mass used in Example 2 was added to an autoclave with 1.5 g of thiourea and 30 ml of water and heated to 180° C. for 16 h. The suspension was cooled naturally in the furnace, washed with water and acetone and air-dried.

### Example 2-14

### Addition of Sulfur as Extraneous Atom

500 mg of the black mass used in Example 2 was added to an autoclave with 50 mg of elemental sulfur (S₈) and 30 ml of water and heated to 180° C. for 16 h. The suspension was cooled naturally in the furnace, washed with water and acetone and air-dried.

### Example 2-15

### Addition of Phosphorus as Extraneous Atom

500 mg of the black mass used in Example 2 was added to an autoclave with 50 mg of red phosphorus and 30 ml of water and heated to 180° C. for 16 h. The suspension was cooled naturally in the furnace, washed with water and acetone and air-dried.

### Example 2-16

### Addition of Sulfur as Extraneous Atom

100 mg of the black mass used in Example 2 was ground and heated to 300° C. (ramp 300° C//h) in a tubular furnace in an H2S atmosphere and the temperature was maintained for 3 hours before being allowed to cool naturally.

### Example 2-17

### Addition of Boron As Extraneous Atom

500 mg of the black mass used in Example 2 was added to an autoclave with 700 mg of boric acid or diboron trioxide and 30 ml of water and heated to 180° C. for 16 hours. The suspension was cooled naturally in the furnace, washed with water and acetone and air-dried.

### Example 2-18

### Addition of Nitrogen as Extraneous Atom

500 mg of the black mass used in Example 2 was added to an autoclave with 3 ml of hydrazine and 27 ml of water and heated to 180°C for 16 h. The suspension was cooled naturally in the furnace, washed with water and acetone and air-dried.

### Example 3

The black mass used is a recyclate from a used battery for electrically driving an electric vehicle, particularly an electric car. The recyclate is a recycled material based on an LFP battery (lithium iron phosphate battery), which was provided by Duesenfeld GmbH (Wendeburg, Germany). The one or more graphite-supported noble metal-free metal oxides of the black mass comprise iron oxide(s). A powder diffractogram of this black mass is shown in FIG. 5.

### Example 3-1

### Addition of Nitrogen as Extraneous Atom

100 mg of the black mass used in Example 3 was first flushed with NH₃ in a tubular furnace for 2 h and subsequently heated to 300° C. (ramp 300° C./h). After 6 h, natural cooling to room temperature was performed.

### Example 3-2

### Chemical Modification of the Black Mass

100 mg of the black mass used in Example 3 was ground and heated to 80° C. in an aqueous solution of 2 M formic acid and 6% H₂O₂ for 2 h. Subsequently, the material was washed with water and acetone and air-dried.

### Example 3-3

### Chemical Modification of the Black Mass

100 mg of the black mass used in Example 3 was ground and heated to 80° C. in an aqueous solution of 1 M KOH for 2 h. Subsequently, the material was washed with water and acetone and air-dried.

### LIST OF REFERENCE SIGNS

1 providing
2 introducing
3 applying
4 determining
5 modifying
6 adding
10 electrolysis cell
11 electrode
12 electrode
14 solvent
15 black mass
16 voltage source
17 coating
20 further electrolysis cell
21 anode
22 cathode
24 alkaline solution
25 diaphragm
26 further voltage source
27 substrate
28 further substrate

1. A process for producing a graphite-containing metal oxide electrode, comprising the following steps
a) providing an electrolysis cell having an electrode, a further electrode and an aqueous and/or nonaqueous carbonyl-and cyano-free solvent
b) introducing a black mass and a proton source into the solvent in the electrolysis cell, the black mass having graphite-supported noble metal-free metal oxides, and
c) applying a voltage to the electrode and the further electrode, so that the noble metal-free metal oxides and graphite provided by means of the black mass are deposited on the electrode in order to produce a graphite-containing metal oxide coating on the electrode to form the graphite-containing metal oxide electrode,
wherein, before step a) or b), the following step is carried out:
adding one or more extraneous atoms to the graphite support of the black mass, the extraneous atoms being nitrogen, sulfur, phosphorus and/or boron.

2. The process as claimed in claim 1, wherein the black mass is a recyclate that is a recycled material from a used battery for electrically driving an electric vehicle.

3. The process as claimed in claim 1, wherein the one or more graphite-supported noble metal-free metal oxides comprise a mixture of Ni, Co and/or Mn and at least one of their oxides, or comprise iron oxide or iron oxides, or comprise a mixture of Ni, Co, Al oxides.

4. The process as claimed in claim 1 wherein, before step a) or step b), the following steps are carried out
determining the composition and morphology of the black mass and
chemically modifying the black mass depending on the determined composition and morphology, comprising a modification of the percentages of metal and/or metal oxide present in the black mass.

5. The process as claimed in claim 1, wherein the extraneous atom or the added extraneous atoms in the graphite support is/are nitrogen.

6. The process as claimed in claim 1, wherein the solvent is selected from the group consisting of cyclic ethers and/or azeotropic alcohol-water mixtures.

7. A graphite-containing metal oxide electrode produced by a process as claimed in claim 1.

8. The use of the graphite-containing metal oxide electrode as claimed in claim 7 for producing hydrogen and/or oxygen by means of photoelectrochemical or electrochemical water splitting.

9. An electrolysis cell for producing hydrogen and oxygen by means of photoelectrochemical or electrochemical water splitting, comprising the graphite-containing metal oxide electrode as claimed in claim 7 as cathode and/or the graphite-containing metal oxide electrode as claimed in claim 7 as anode.

10. The electrolysis cell as claimed in claim 9, comprising an alkaline solution as electrolysis solution.
